(19) United States
(12) Patent Application Publication
(10) Pub. No.: US 2024/0012245 A1
(43) Pub. Date: Jan. 11, 2024

(54) STEERABLE CAMERA ARRAY FOR HEAD-MOUNTED DISPLAY DEVICES

(71) Applicant: GOOGLE LLC, Mountain View, CA (US)

(72) Inventors: Daniel Adema, Kitchener (CA); Stuart James Myron Nicholson, Waterloo (CA)

(21) Appl. No.: 18/035,563

(22) PCT Filed: Dec. 18, 2020
(86) PCT No.: PCT/US2020/066114

§ 371 Date: May 5, 2023

(51) Int. Cl. G02B 27/01

(52) U.S. Cl. CPC G02B 27/0172; G02B 2027/0178; G02B 2027/0138; G02B 2027/014

(57) ABSTRACT

A head wearable apparatus, such as a pair of smart glasses are configured to track a gaze direction of a person for various applications. To support the tracking, the head wearable apparatus is configured with a lens assembly including at least one lens module (e.g., a lens or a lenslet array) operably coupled to the head wearable apparatus and a camera assembly including a camera sensor operably coupled to the head wearable apparatus. The head wearable apparatus is also configured with a camera assembly operably coupled to an anterior surface of a flexure of the head wearable apparatus (e.g., proximate to the front of the smart glasses frames) to minimize a size (e.g., to be as small as possible) of an aperture housing the camera assembly. The flexure is configured to be adjacent to the lens assembly operably coupled to the head wearable apparatus.

### BACKGROUND

The use of head mounted display (HMD) devices, such as smartglasses, continues to increase at a rapid pace. For instance, head wearable apparatuses have increasingly become an integral part of the way in which users interact with different computer applications, such as virtual reality (VR) applications, augmented reality (AR) applications, gaming applications, among other examples. Typically, these HMD devices are configured with a small display system (e.g., an optic in front of one (monocular HMD) or each eye (binocular HMD)), a camera, and other electronic components operably configured with the display system and the camera to support various operations. However, existing configurations of these components can require large or bulky HMD form factors, or can cause poor camera performance, resulting in a poor user experience. Some wearable devices, such as smart eyeglasses, have insufficient space to support both a display system and a camera being positioned side-by-side in the same physical region of the smart eyeglasses (e.g., on the same temple (also referred to as arm) of the smart eyeglasses, or on the same frame front of the smart eyeglasses and still meet an acceptable form factor). In order to support binocular eyeglasses (i.e., a display in both eyes), it is desirable for the display system and the camera to coexist in the same region of the smart eyeglasses.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a wearable device in accordance with some embodiments.

FIG. 2 illustrates a front perspective-view of a flexure and a camera assembly of a wearable device in accordance with some embodiments.

FIG. 3 illustrates a side perspective-view of the flexure and the camera assembly of the wearable device in accordance with some embodiments.

FIG. 4 illustrates a front perspective-view of a flexure and a camera assembly of a wearable device in accordance with some embodiments.

FIG. 5 illustrates a side perspective-view of the flexure and the camera assembly of the wearable device in accordance with some embodiments.

FIG. 6 illustrates a front perspective-view of a flexure and a camera assembly of a wearable device in accordance with some embodiments.

FIG. 7 illustrates a side perspective-view of the flexure and the camera assembly of the wearable device in accordance with some embodiments.

FIG. 8 illustrates a side perspective-view of a flexure and a camera assembly of a wearable device in accordance with some embodiments.

FIG. 9 illustrates a side perspective-view of the flexure and the camera assembly of the wearable device in accordance with some embodiments.

FIG. 10 illustrates a side perspective-view of the flexure and the camera assembly of the wearable device in accordance with some embodiments.

FIG. 11 illustrates a top perspective-view of the flexure and the camera assembly of the wearable device in accordance with some embodiments

FIG. 12 illustrates a side perspective-view of the flexure and the camera assembly of the wearable device in accordance with some embodiments.

FIG. 13 illustrates a side perspective-view of the flexure and the camera assembly of the wearable device in accordance with some embodiments.

FIGS. 14A through 14D illustrates perspective-views of the wearable device in accordance with some embodiments.

FIG. 15 is a block diagram of a wearable device in accordance with some embodiments.

### DETAILED DESCRIPTION

Typically, a head wearable apparatus (or device), such as smartglasses are configured with a small display system (e.g., an optic in front of one (monocular HMD) or each eye (binocular HMD)), a camera system, and other electronic components operably configured with the display system and the camera to support various operations. The available volume adjacent to the display system for the camera system is significantly limited by the desired form factor of the smartglasses. However, the central gaze direction (also referred to as field-of-view) of the user is typically 5 degrees wide, and the para-central gaze direction is typically 8 degrees wide. A user will turn their eyes within a range of about +/−15 degrees to view an object. When an object of interest falls outside of this range, the user might typically turn their head to see the object clearly. It may be desirable to have a camera assembly configured with the head wearable apparatus that might be limited to having a field-of-view comparable to the central or paracentral region of the user, to be capable to monitor the gaze direction of the user and adjust the pointing direction of the camera assembly so that the gaze direction of the user is within the field-of-view of the camera assembly.

Various aspects of the present disclosure relate to a head wearable apparatus (e.g., smartglasses) configured with a display system (also referred to as display interface) and a camera coexisting on the same side of the head wearable apparatus. For example, the wearable apparatus is configured with a lens assembly including at least one lens module (e.g., at least one lens or a lenslet array) operably coupled to the head wearable apparatus and a camera assembly including at least one sensor (e.g., a camera sensor, among other examples) operably coupled to the head wearable apparatus. In some embodiments, the head wearable apparatus may be configured with a sensory array (e.g., up to five sensors, with each sensor being an array of 400×400 pixels or 400×300 pixels, etc.). The head wearable apparatus is also configured with a camera assembly operably coupled to an anterior surface of a flexure of the head wearable apparatus (e.g., proximate to the front of the smart eyeglasses frames) to minimize a size of an aperture housing the camera assembly (also referred to as camera assembly housing) and the optical aperture window. The flexure is configured to be adjacent to the lens assembly operably coupled to the head wearable apparatus and control rotation of the camera assembly via its axis. As such, the direction of scanning of the camera array may be horizontal. In other words, the flexure allows rotation of the camera array to track the side-to-side movement of the user's eyes.

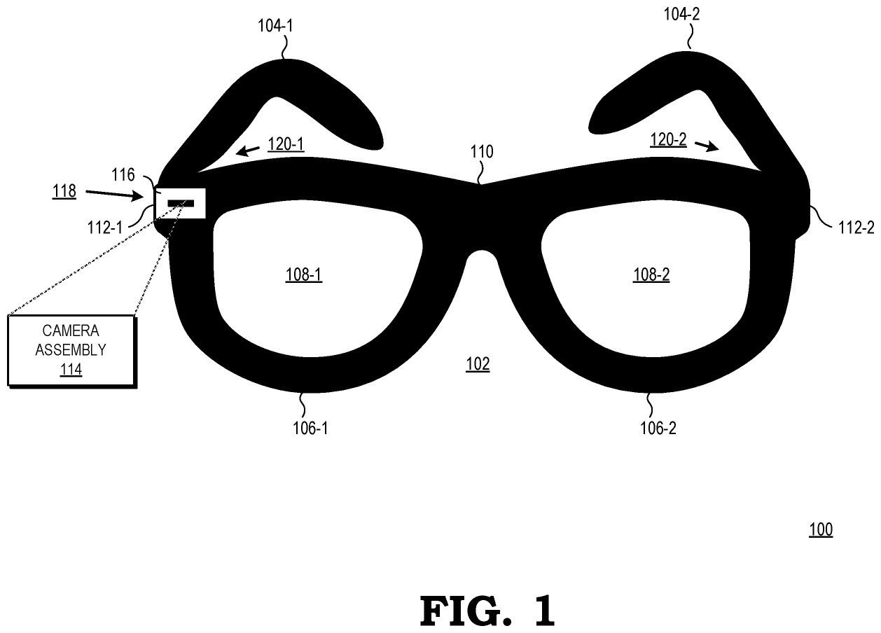

FIG. 1 illustrates a wearable device 100 in accordance with some embodiments. The wearable device 100 may be an example of a pair of smart eyeglasses configured to track a gaze direction of a person wearing the smart eyeglasses for various applications, such as streaming applications, gaming applications, among other examples. In some other embodiments, the wearable device 100 is another head-wearable device, such as a head-mounted display (HMD) device that has a display optic in front of one (monocular HMD) or each eye (binocular HMD).

The device 100 may be worn on a user's head and, when so worn, secures at least one electronic display within a viewable field of at least one of the user's eyes, regardless of the position or orientation of the user's head. The device 100 as described herein may include a display system that enables a user to see displayed content but also does not prevent the user from being able to see their external physical environment. The display system may be either transparent or at the periphery of the user's field-of-view (gaze direction), so that it does not completely block the user from being able to see their external physical environment.

As illustrated in FIG. 1, the wearable device 100 includes a frame 102, which may be composed of plastic and acetate or other materials. These materials can be used to produce frames of all colors, shapes, patterns, and even textures while maintaining a comfortable lightweight. In some other embodiments, the frame 102 may be composed of a metal material. This material can be used for rimless and semi-rimless frame styles and support a variety of shapes, colors, and styles. The frame 102 includes a pair of temples 104 (also referred to as arms or holders) that extend in a first direction along a first axis when in a first configuration (e.g., folded) and along a second axis when in a second configuration (e.g., unfolded). In some embodiments, the pair of temples includes a first temple 104-1 and a second temple 104-2 that are parallel to each other and are perpendicular to the frame 102 when in an unfolded configuration. The frame 102, in some embodiments, includes a pair of shoulders 120 including a first shoulder 120-1 which span a region between the lens 108-1 and the temple 104-1, and a second should 120-2 which may span a region between the lens 108-2 and the temple 104-2.

In some embodiments, the frame 102 includes a pair of lens holders 106 including a first lens holder 106-1 and a second lens holder 106-2. A pair of lenses 108 are operably coupled to the pair lens holders. For example, a first lens 108-1 is operably coupled to a first lens holder 106-1 and a second lens 108-2 is operably coupled to a second lens holder 106-2. The frame 102 includes a foreframe 110 including a bridge that is the center of the frame 102 and that rests on a person's nose and joins the lens holders 106 together.

The frame 102 includes a pair of flexures 112 including a first flexure 112-1 and a second flexure 112-2. The flexures 112 may be curved or bent to fit the frame 102 configuration. In some embodiments, the pair of flexures 112 are proximate to the foreframe 110. In some other embodiments, the pair of flexures 112 are proximate to the pair of temples 104 (also referred to as arms holders). The pair of flexures 112 may be shaped to fit the configuration of the frame 102. It may be attached to the foreframe 110 and at least one temple 104 of the pair of temples 104 by one or more means. Although the wearable device 100 illustrates multiple components, the present disclosure applies to any wearable device 100 architecture having more or fewer components.

The frame 102 may include an “eyeward” side that faces the user's eyes when the frames are worn and an “outward” side that is opposite the eyeward side. In the example of FIG. 1, at least one shoulder 120 may include a lens module coupled to at least one surface of the frame 102 and a camera assembly 114 operably coupled to an anterior surface of a flexure 112 (e.g., the flexure 112-1) on the outward side of the frame 102. That is, the anterior surface of the flexure 112 may be part of the flexure 112 (body) that faces forward. The flexure 112-1 may be adjacent to the at least one lens 108. The camera assembly 114 may include at least one sensor to track a gaze direction of a user wearing the wearable device 100. In some embodiments, the lens module includes at least one lens or a lenslet array. The camera assembly 114 may be configured to track a position of at least one eye of the user based on a direction of the at least one eye of the user (e.g., a gaze related to movements of the head), or an orientation of the at least one eye of the user, or both. In some embodiments, the wearable device 100 may be configured with an actuator or other motor component coupled to the camera assembly 114 and configured to adjust a pointing direction of the at least one sensor (e.g., a camera sensor) or a sensing orientation of the at least one sensor, or both, as described herein.

At least one lens 108 may be configured with a display interface of a display system that enables a user to see displayed content but also does not prevent the user from being able to see their external physical environment. The display interface may be either transparent or at the periphery of the user's field-of-view (e.g., gaze direction), so that the user is able to see at least part of the surrounding physical environment. In some embodiments, the display interface may be overlaid, for example, positioned on or proximate to a surface of the at least one lens 108, and be in parallel with the at least one lens 108. The display interface may correspond to an eyebox which may define a range of eye positions over which specific content displayed on via the display interface is visible to the user. The eyebox may be referred to as a volume in space positioned near the display interface of the at least one lens 108. When the eye of the user (and more particularly, the pupil of the eye of the user) is positioned inside this volume and facing the display interface of the at least one lens 108, the user is able to see all of the content displayed on the display interface. When the eye of the user is positioned outside of this volume, the user is not able to see at least some of the content provided by the display interface.

The camera assembly 114 may be operably coupled to a controller configured to control an operating mode of the at least one sensor of the camera assembly 114. For example, separate camera sensors or sub-regions of camera sensors (e.g. pixel binning) of the camera assembly 114 may be used to reduce power consumption of the wearable device 100 by having a single sensor remain active (e.g., always-ON) for sensing purposes, and wake up other sensors when required. In other embodiments, the camera assembly 114 may employ a single camera sensor or a plurality of the camera sensors perform or assist with various operations (e.g., sensing, monitoring, etc.). For example, a single camera sensor may sense and monitor light waves (as they pass through or reflect off objects) into signals, small bursts of current that convey the information (e.g., used to make an image). The waves can be light or other electromagnetic radiation. A camera sensor may be a charge-coupled device (CCD) or an active-pixel sensor (CMOS sensor), or the like. In some embodiments, a size of at least one camera sensor of the camera assembly 114 is different from a size of another camera sensor of the camera assembly 114. A size of a camera sensor may determine how much light it uses to create an image. A bigger sensor may thus gain more information (e.g., light waves) than a smaller one and produce better images. In some embodiments, pixels associated with a camera sensor may be binned. The camera assembly 114 may also include an array of camera sensors, where a length (height) of the array of camera sensors is greater than a width of the array of camera sensors as described herein.

In some embodiments, a portion of an anterior surface 118 (e.g., on an outward side as described herein) of a flexure 112 includes a mechanical housing 116 of the camera assembly 114 and an optical aperture window. An orientation of the camera assembly 114 may be in a vertical column of the aperture 116. The mechanical housing 116 may include an optical aperture having an opening having an anterior surface and the camera assembly 114 is positioned in relation to the anterior surface to track the gaze direction of the user. In some embodiments, the anterior surface includes a transparent material. In some other embodiments, a size of the mechanical housing 116 is based on a size of the portion of the flexure 112 of the wearable apparatus, for example, in one or more dimensions including direction and orientation (e.g., a vertical direction, a horizontal direction, an angle, etc.). An axis of rotation of the flexure 112 of the wearable device 100 is proximate to the anterior surface of the foreframe 110. The camera assembly 114 may be in electrical communication with one or more components of the wearable device 100 via an electrical interface coupled to the flexure 112 of the wearable device 100. The electrical interface may include a printed circuit board (PCB). The electrical interface may be used to route information (e.g., image data, sensor information) between the camera assembly 114 and one or more components, as described herein.

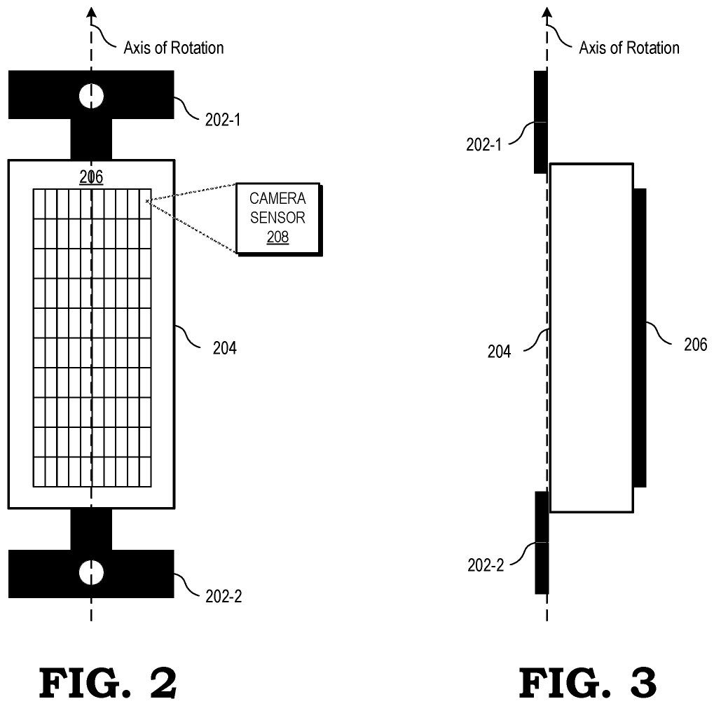

FIG. 2 illustrates a front perspective-view of a flexure and a camera assembly of a wearable device in accordance with some embodiments, and FIG. 3 illustrates a side perspective-view of the flexure and the camera assembly of the wearable device in accordance with some embodiments. The wearable device includes a pair of flexures 202 including a first flexure 202-1 and a second flexure 202-2 operably coupled to a substrate 204. For example, the first flexure 202-1 may be operably coupled to a first part (e.g., surface) of the camera assembly 204, while the second flexure 202-2 may be operably coupled to a second part (e.g., surface) of the camera assembly 204. The camera assembly 204 may be configured to include an array of camera sensors 206 including one or more single camera sensor 208. The camera assembly 204 may also include an array of camera sensors, where a length of the array of camera sensors is greater than a width of the array of camera sensors, to reduce a footprint of the camera assembly 204. One or more of these components (e.g., the camera assembly 204) may be operably adjusted with respect to an axis of rotation.

In some embodiments, the camera assembly 204 may include 1-4 sensors, and each sensor may have a significant number of pixels (e.g., 400×400 pixels per sensor). For example, the camera assembly 204 may include an array of N×M camera sensors, where N is a number camera sensors in a vertical direction and M is a number of camera sensors in a horizontal direction. Each camera sensor may have an aspect ratio of P×Q pixels, where P is a number of pixels in a horizontal direction and Q is a number of pixels in a vertical direction. As described herein, N may be greater than M to reduce a footprint of the camera assembly 204 and to allow the camera assembly 204 to be configured with the flexure 202, which may allow the camera assembly 204 to coexist on the same side of the wearable device, as a display system as described herein. In some embodiments, N is at least a factor (e.g. multiple) of M, for example, N may be 1.5*M.

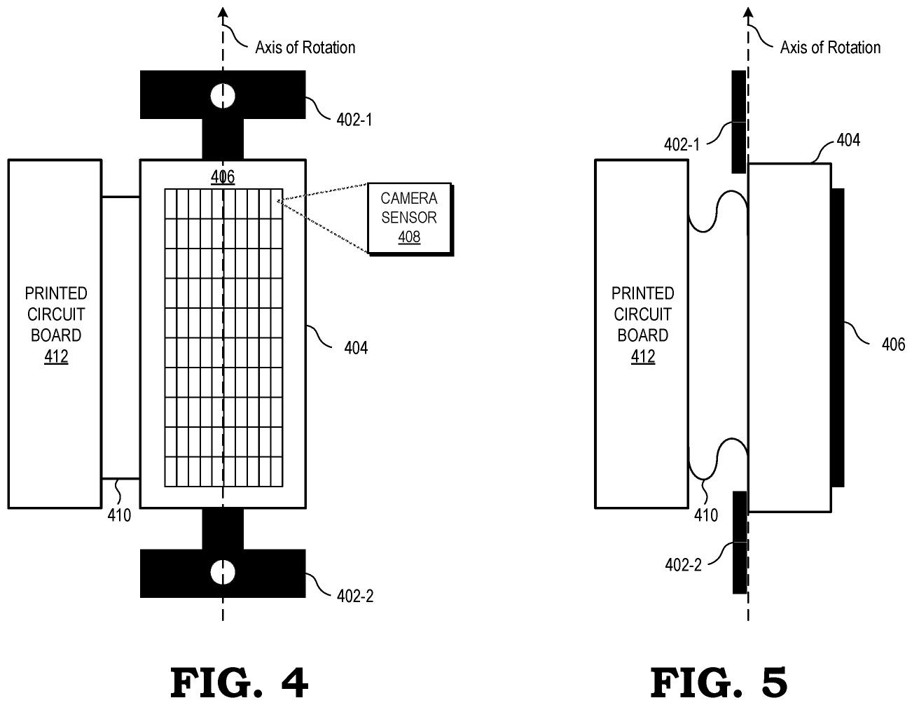

FIG. 4 illustrates a front perspective-view of a flexure and a camera assembly of a wearable device in accordance with some embodiments, and FIG. 5 illustrates a side perspective-view of the flexure and the camera assembly of the wearable device in accordance with some embodiments. The wearable device may include a minimum number of device electronics (e.g., integrated circuits) in a moveable (adjustable) portion of the wearable device. The wearable device includes a pair of flexures 402 including a first flexure 402-1 and a second flexure 402-2 operably coupled to a camera assembly 404. For example, the first flexure 402-1 may be operably coupled to a first part (e.g., surface) of the camera assembly 404, while the second flexure 402-2 may be operably coupled to a second part (e.g., surface) of the camera assembly 404. The camera assembly 404 may be configured to include an array of camera sensors 406 including one or more single camera sensors 408. One or more of these components (e.g., the camera assembly 404) may be operably adjusted with respect to an axis of rotation.

In the examples of FIGS. 4 and 5, the wearable device includes a connector 410 (e.g., a flex harness) operably coupled to a PCB 412. The moveable portion of the camera assembly 404 includes the array of camera sensors 406 including the one or more single camera sensors 408. The connector 410 may provide a circuit path to the PCB 412 where a subset of the camera assembly 404 electronics reside. The connector 410 may be made of flexible-based material, for example, copper, aluminum, nickel, gold, and silver etc. The PCB 412 may also be used to perform other operations (e.g., image processing, image recognition, tracking) based on information conveyed from the camera assembly 404. Thus, in the examples of FIGS. 4 and 5, the wearable device may include a minimum number of device electronics (e.g., integrated circuits) in a moveable (adjustable) portion of the wearable device by allocating most operations to be performed on the PCB 412.

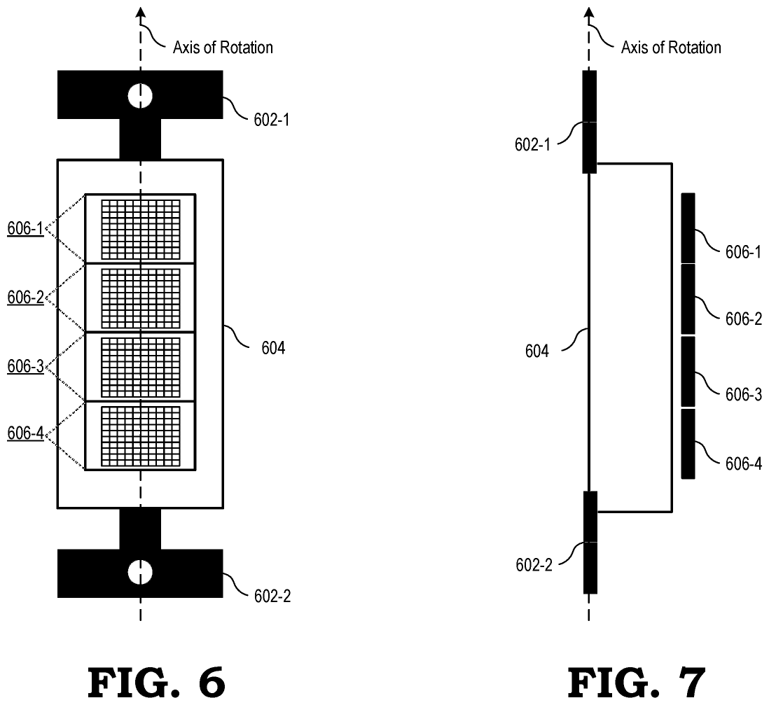

FIG. 6 illustrates a front perspective-view of a flexure and a camera assembly of a wearable device in accordance with some embodiments, and FIG. 7 illustrates a side perspective-view of the flexure and the camera assembly of the wearable device in accordance with some embodiments. The wearable device includes a pair of flexures 602 including a first flexure 602-1 and a second flexure 602-2 operably coupled to a camera assembly 604. For example, the first flexure 602-1 may be operably coupled to a first part (e.g., surface) of the camera assembly 604, while the second flexure 602-2 may be operably coupled to a second part (e.g., surface) of the camera assembly 604. One or more of these components (e.g., the camera assembly 604) may be operably adjusted with respect to an axis of rotation.

The camera assembly 604 may be configured to include an array of camera sensors 606 including a first camera sensor 606-1, a second camera sensor 606-2, a third camera sensor 606-3, and a fourth camera sensor 606-4. The multiple camera sensors 606 including the first camera sensor 606-1, the second camera sensor 606-2, the third camera sensor 606-3, and the fourth camera sensor 606-4 may be coplanar. Although only a single array of camera sensors 606 is illustrated, the present disclosure may support additional arrays of camera sensors. These camera sensors 606 may be coupled to an anterior surface of the flexure 602 as described in FIG. 1.

Each camera sensors 606 may be made up of the same or different sizes (e.g., pixels). The size of each camera sensor 606 determines how much light it uses to create visual information (e.g., an image). Each camera sensor 606 consists of a number of light-sensitive spots referred to as photosites, which are used to record and store information about what is seen through a lens of the wearable device. As such, a bigger camera sensor may gain more visual information than a smaller camera sensor and produce better visual information (e.g., images).

In some embodiments, a single separate camera sensor 606 of the camera assembly 604 may be used to reduce power consumption of the wearable device by having the single camera sensor 606 remain active (e.g., always-ON) for sensing purposes, and wake up other camera sensors 606 when required. For example, the first camera sensor 606-1 may be configured to remain active for various operations (e.g., tracking a narrow gaze direction), and be configured to trigger (e.g., wake up) the second camera sensor 606-2, the third camera sensor 606-3, or the fourth camera sensor 606-4, or a combination thereof, based on certain operations (e.g., tracking a wide gaze direction).

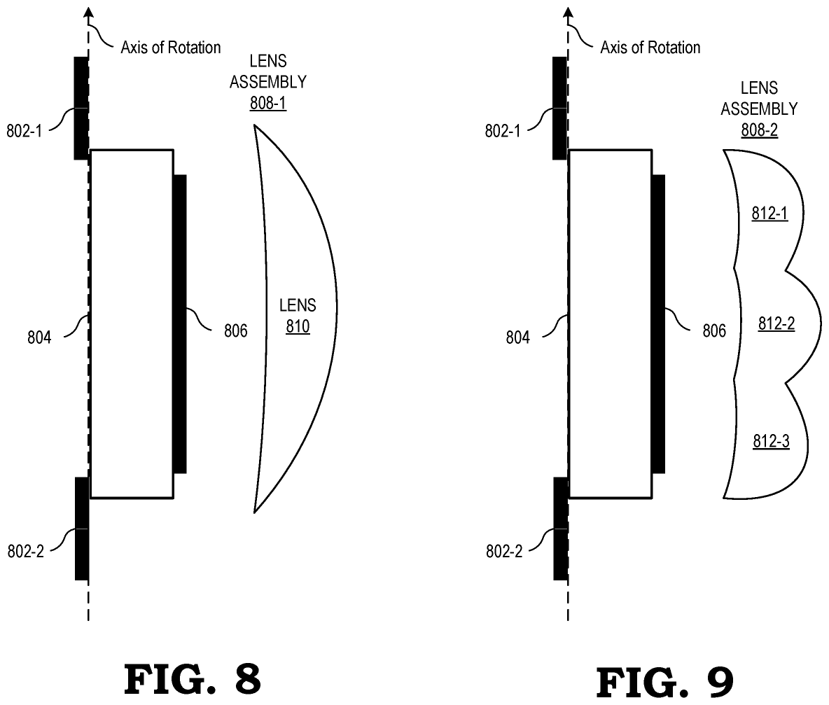

FIG. 8 illustrates a side perspective-view of a flexure and a camera assembly of a wearable device in accordance with some embodiments, and FIG. 9 illustrates a side perspective-view of the flexure and the camera assembly of the wearable device in accordance with some embodiments. The wearable device includes a pair of flexures 802 including a first flexure 802-1 and a second flexure 802-2 operably coupled to a camera assembly 804. For example, the first flexure 802-1 may be operably coupled to a first part (e.g., surface) of the camera assembly 804, while the second flexure 802-2 may be operably coupled to a second part (e.g., surface) of the camera assembly 804. One or more of these components (e.g., the camera assembly 804) may be operably adjusted with respect to an axis of rotation.

The camera assembly 804 may be proximate to a lens assembly 808-1 that is coupled to at least one surface of a frame of the wearable device. In some other embodiments, sensors or a sensory array associated with the camera assembly 804 may rotate separately from a lens 810 associated with the lens assembly 808-1. In other embodiments, the lens 810 may rotate with the sensors or the sensory array associated with the camera assembly 804. In the example of FIG. 8, the lens assembly 808-1 may include a single lens 808. Alternatively, in the example of FIG. 9, the lens assembly 808-1 may include a lenslet 812 including a first lens 812-1, a second lens 812-2, and a third lens 812-3. Thus, as illustrated in FIGS. 8 and 9, either a single lens assembly or a lenslet assembly can be used. The lens 810 or the lenslet 812 may have different or varying focal lengths (like an eyeglass progressive lens) so that different regions can be viewed (i.e., distance, intermediate, reading distance, a wide-angle region, etc.). The optical properties of each region may be different (e.g., magnification, MTF etc.) as each region may be used for different experiences on the wearable device. Although the lens 810 and lenslet 812 are illustrated as a single optical element, both the lens 810 and the lenslet 812 may consist of a number of optical elements, for example, such as in a focusable lens assembly.

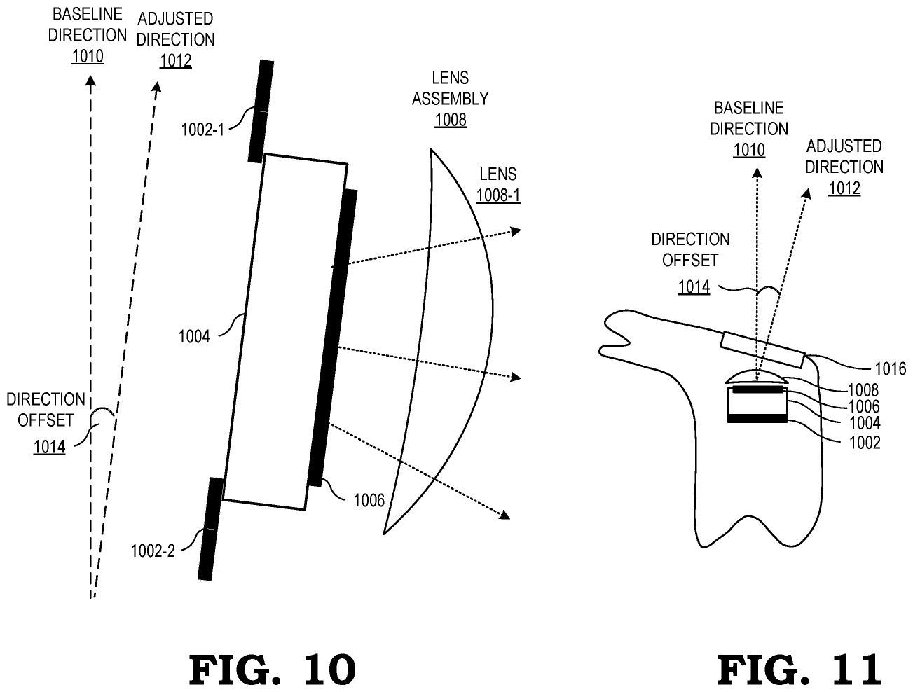

FIG. 10 illustrates a side perspective-view of the flexure and the camera assembly of the wearable device in accordance with some embodiments. FIG. 11 illustrates a top perspective-view of the flexure and the camera assembly of the wearable device in accordance with some embodiments. The wearable device includes a pair of flexures 1002 including a first flexure 1002-1 and a second flexure 1002-2 operably coupled to a camera assembly 1004. For example, the first flexure 1002-1 may be operably coupled to a first part (e.g., surface) of the camera assembly 1004, while the second flexure 1002-2 may be operably coupled to a second part (e.g., surface) of the camera assembly 1004. The camera assembly 1004 may be configured to include a camera sensor 1006. The camera assembly 1004 may be proximate to a lens assembly 1008 that is coupled to at least one surface of a frame of the wearable device. The lens assembly 1008 may include a single lens 1008-1. In some embodiments, an aperture 1016 as described herein, for example, may hold (e.g., house) the camera assembly 1004 among other components.

In the example of FIG. 10, the wearable device via an actuator (or other motor) may be configured to adjust a direction of the camera assembly 1004 (e.g., move the camera array side to side, for example, in-and-out), and thereby a pointing direction of a field-of-view of the camera assembly 1004 as described herein. For example, the wearable device via an actuator (or other motor) may be configured to adjust a pointing direction of the camera assembly 1004 in order to align a focus plane of the lens 1008-1. In some embodiments, the wearable device via an actuator (or other motor) may be configured to adjust a camera sensor (or an array of camera sensors) of the camera assembly 1004 from a baseline direction 1010 to an adjusted direction 1012, for example, based on tracking a gaze direction of the user wearing the wearable device. In some other embodiments, the wearable device via an actuator (or other motor) may be configured to adjust the camera assembly 1004 from the baseline direction 1010 to the adjusted direction 1012 based on a preconfigured setting (e.g. a direction offset value 1014).

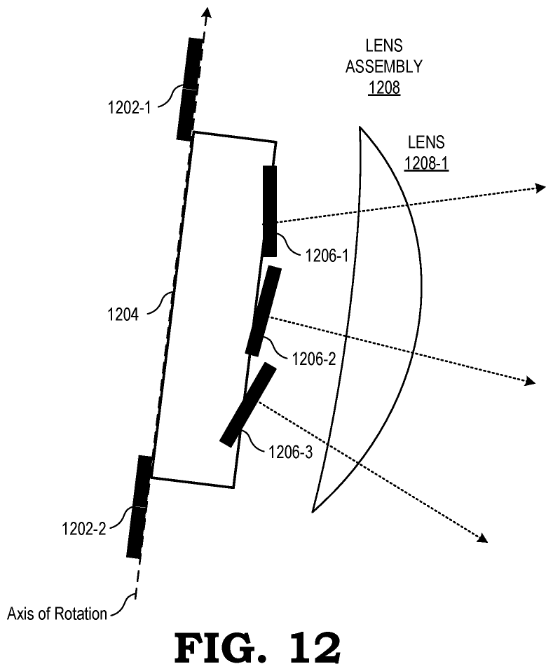

FIG. 12 illustrates a side perspective-view of the flexure and the camera assembly of the wearable device in accordance with some embodiments. The wearable device includes a pair of flexures 1202 including a first flexure 1202-1 and a second flexure 1202-2 operably coupled to a camera assembly 1204. For example, the first flexure 1202-1 may be operably coupled to a first part (e.g., surface) of the camera assembly 1204, while the second flexure 1202-2 may be operably coupled to a second part (e.g., surface) of the camera assembly 1204. The camera assembly 1204 may be configured to include multiple arrays of camera sensors 1206 including a first array of camera sensors 1206-1, a second array of camera sensors 1206-2, and a third array of camera sensors 1206-3. The camera assembly 1204 may be proximate to a lens assembly 1208 that is coupled to at least one surface of a frame of the wearable device. The lens assembly 1208 may include a single lens 1208-1.

In the example of FIG. 12, the wearable device via one or more actuators (or other motor) may be configured to adjust a direction of the camera assembly 1204 (e.g., move the camera array side-to-side on a corresponding axis, for example, in-and-out), and thereby steer a pointing direction of the field-of-view of the camera assembly 1204 as described herein. For example, the wearable device via one or more actuators may be configured to adjust a direction of one or more arrays of camera sensors 1206 including the first array of camera sensors 1206-1, the second array of camera sensors 1206-2, or the third array of camera sensors 1206-3, or a combination thereof, in order to align to the focus plane of the lens 1208-1. That is, the camera sensors 1206 are inclined to a fixed orientation to align to the focal plane of the lens 1208-1. The actuator thereby scans the camera sensors 1206 side-to-side (in/out of the page). In some embodiments, the wearable device via an actuator (or other motor) may be configured to adjust one or more arrays of camera sensors 1206 of the camera assembly 1204. In some other embodiments, the wearable device via an actuator (or other motor) may be configured to adjust the camera assembly 1204 based on a preconfigured setting. In the example of FIG. 12, one or more of the camera sensors 1206 may be tilted to align to one or more focal planes of the optics (e.g., the lens 1208-1). In some embodiments, this tilt may be a static tilt. That is, the tilt does not get adjusted by an actuator when changing the pointing direction of the one or more camera sensors 1206.

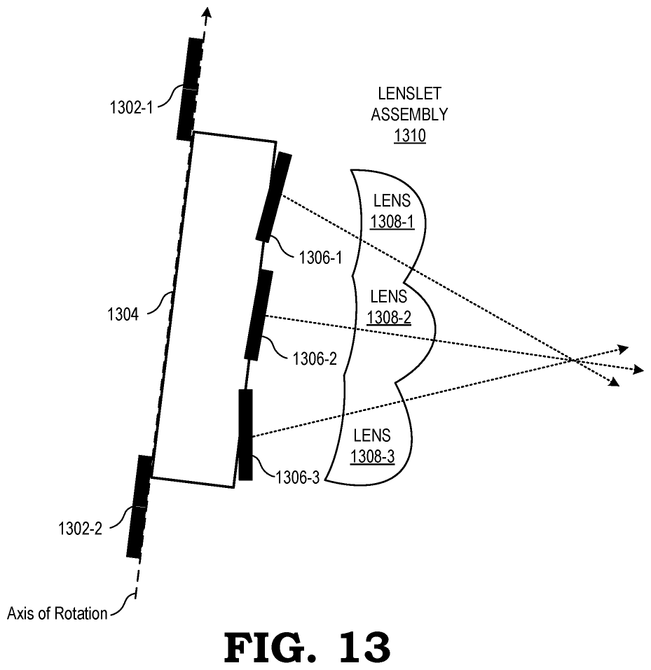

FIG. 13 illustrates a side perspective-view of the flexure and the camera assembly of the wearable device in accordance with some embodiments. The wearable device includes a pair of flexures 1302 including a first flexure 1302-1 and a second flexure 1302-2 operably coupled to a camera assembly 1304. For example, the first flexure 1302-1 may be operably coupled to a first part (e.g., surface) of the camera assembly 1304, while the second flexure 1302-2 may be operably coupled to a second part (e.g., surface) of the camera assembly 1304. The camera assembly 1304 may be configured to include multiple arrays of camera sensors 1306 including a first array of camera sensors 1306-1, a second array of camera sensors 1306-2, and a third array of camera sensors 1306-3. The camera assembly 1304 may be proximate to a lenslet assembly 1308 that is coupled to at least one surface of a frame of the wearable device. The lenslet assembly 1310 may include multiple single lens 1308, for example, a first lens 1301-1, a second lens 1308-2, and a third lens 1308-3.

In the example of FIG. 13, the wearable device via an actuator (or other motor) may be configured to adjust a direction of the camera assembly 1304 (e.g., move the camera array side-to-side on a corresponding axis, for example, in-and-out), and thereby steer a pointing direction of the field-of-view of the camera assembly 1304 as described herein. For example, the wearable device via an actuator (or other motor) may be configured to adjust a direction of one or more arrays of camera sensors 1306 including the first array of camera sensors 1306-1, the second array of camera sensors 1306-2, and or the third array of camera sensors 1306-3, or a combination thereof, in order to align to the focus plane of the lenslet assembly 1310. As such, the camera sensors 1306 are inclined to a fixed orientation to align to the focal plane of the lenslet assembly 1310. The actuator thereby scans the camera sensors 1306 side-to-side on a corresponding axis (in/out of the page). In some embodiments, the wearable device via an actuator (or other motor) may be configured to adjust one or more arrays of camera sensors 1306 of the camera assembly 1304. In some other embodiments, the wearable device via an actuator (or other motor) may be configured to adjust the camera assembly 1304 based on a preconfigured setting. In the example of FIG. 13, one or more of the camera sensors 1306 may be tilted to align to one or more focal planes of the optics (e.g., the one or more lenses 1308). In some embodiments, this tilt may be a static tilt. That is, the tilt does not get adjusted by an actuator when changing the pointing direction of the one or more camera sensors 1306.

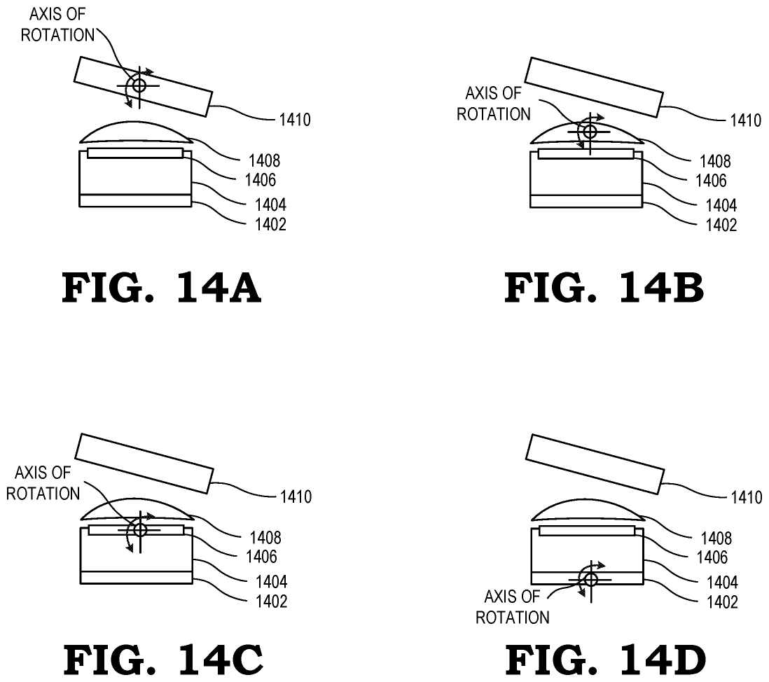

FIGS. 14A through 14D illustrates perspective-views of the wearable device in accordance with some embodiments. The wearable device includes a flexure 1402 operably coupled to a camera assembly 1404. For example, the flexure 1402 may be operably coupled to a first part (e.g., surface) of the camera assembly 1404. The camera assembly 1404 may be configured to include a camera sensor 1406. The camera assembly 1404 may be proximate to a lens assembly 1408 that is coupled to at least one surface of a frame of the wearable device. The lens assembly 1408 may include a single lens or multiple lenses (e.g., a lenslet).

In the example of FIG. 14, the wearable device may be configured to adjust a direction of the camera assembly 1404 (e.g., move the camera array side to side, for example, in-and-out), and thereby a pointing direction of a field-of-view of the camera assembly 1404 as described herein. For example, the wearable device may be configured to adjust a pointing direction of the camera assembly 1404 in order to align a focus plane of the lens 1408. In some embodiments, the wearable device may be configured to adjust a camera sensor (or an array of camera sensors) of the camera assembly 1404, for example, based on tracking a gaze direction of the user wearing the wearable device. In some other embodiments, the wearable device may be configured to adjust the camera assembly 1404 based on a preconfigured setting.

In some embodiments, an aperture 1410 as described herein, for example, may hold the camera assembly 1406. The aperture 1410 that may include an opening and the camera assembly 1406 may be positioned to track a gaze direction of a user wearing the wearable device. In some embodiments, an axis of rotation of the aperture (e.g., of the wearable device) is proximate to an anterior surface of the wearable device. For example, an axis of rotation may be as close as possible to the front of a pair of eyeglass frames in order to keep the window aperture as small as possible.

As illustrated in FIGS. 14A through 14D, the axis of rotation may be different depending on different conditions. As illustrated in FIG. 14A, in some embodiments, the axis of rotation is aligned to the aperture 1410 in order to minimize the aperture 1410 opening size. In some other embodiments, as illustrated in FIG. 14B, the axis of rotation is aligned to the lens 1408 (e.g., or lens assembly) for optical performance. As illustrated in FIG. 14C, in other embodiments, the axis of rotation is aligned to the focal plane (or average focal plane if there are multiple focal planes) of the lens 1408 (also coincident with the camera sensor(s) 106), also for optical performance. Alternatively, as illustrated in FIG. 14D, in some embodiments, the axis of rotation is aligned to another location simply because that is where it is easiest to make or mount the components.

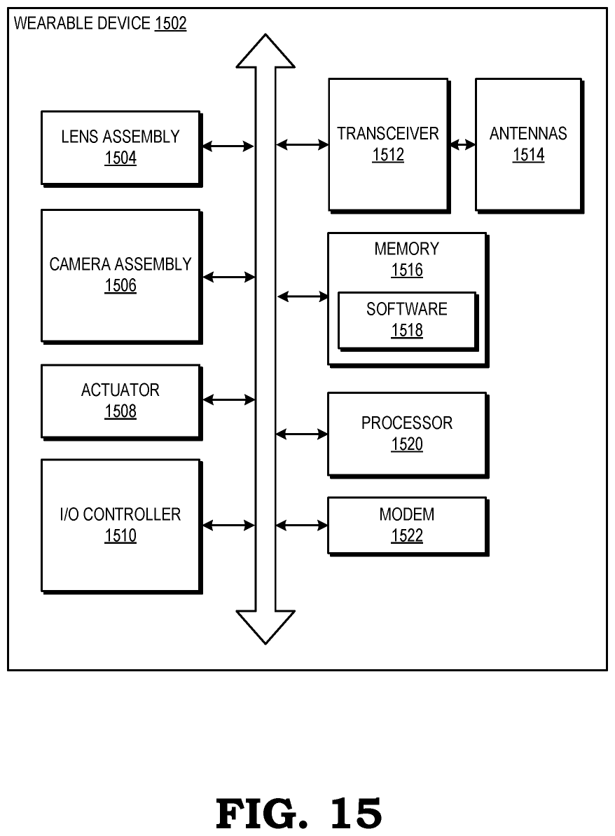

FIG. 15 is a block diagram of a wearable device 1502 in accordance with some embodiments. The wearable device 1502 may be an example of a head-mounted display device or other head-wearable devices, as described in FIG. 1. The wearable device 1502 may include components for bi-directional data communications including components for transmitting and receiving communications (e.g., sensor information, visual information), including a lens assembly 1504, a camera assembly 1506, an actuator 1508, an input/output (I/O) controller 1510, a transceiver 1512, antennas 1514, a memory 1516, a processor 1520, and a modem 1522. These components can be in electronic communication via one or more interfaces (e.g., buses, a printed circuit board (PCB)). For example, a flexible electrical connector may connect the camera assembly 1506 to the rest of the wearable device 1502 components (e.g., the actuator 1508, the I/O controller 1510, the transceiver 1512, the antennas 1514, the memory 1516, the processor 1520, and the modem 1522). Alternatively, a flex PCB may be part of the camera assembly 1506, and sensors or sensor boards may exclusively rotate to track a user's gaze wearing the device wearable 1502, as described herein.

The lens assembly 1504 may include at least one lens or a lenslet array. In some embodiments, the lenslet array includes a set of lenslets in a same plane (e.g., x-plane, y-plane, z-plane). Each lenslet, in some embodiments, has the same focal length or different focal lengths, or a combination thereof. The lens assembly 1504 may be coupled to at least one surface of a frame of the wearable device 1502. For example, the wearable device 1502 may be a pair of wireless or wired eyeglasses having a frame and a pair of temples (also referred to as arms) that extend in a direction perpendicular to the frame of the pair of wireless eyeglasses, for example, when in an unfolded configuration. In some embodiments, the pair of temples extend in a direction parallel to the frame of the pair of wireless or wired eyeglasses, for example, when in a folded configuration. As such, the lens assembly 1504 may be coupled to at least one temple of the frame of the pair of wireless or wired eyeglasses. It should be understood that other coupling configurations are possible.

The camera assembly 1506 may be a high-aspect-ratio camera including at least one camera sensor (also referred to as an image sensor). For example, the camera assembly 1506 may include a single image sensor. In some embodiments, the camera assembly 1506 includes an array of camera sensors. For example, the camera assembly 1506 may include an array of image sensors, such as four camera sensors including a number of pixels (e.g., 400×800 pixels). The camera assembly 1506, in some other embodiments, includes multiple arrays of camera sensors. In some embodiments, the camera sensors of an array of camera sensors are non-coplanar, for example, to increase an image focus. In some other embodiments, the camera sensors of an array of camera sensors are coplanar, for example, to increase an image focus. The separate camera sensors of the camera assembly 1506 may also be used to reduce power consumption of the wearable device 1502 by having a single sensor remain active (e.g., always-ON) for sensing purposes, and wake up other sensors when required. Other functionality use cases may also have a single camera sensor or some of the other camera sensors.

The camera assembly 1506 may be operably coupled to an anterior surface of a flexure of a frame of the wearable device 1502. In some embodiments, the flexure is adjacent to the lens assembly 1504. A flexure of the wearable device 1502 may include a bent or curved portion of an anterior surface (i.e., frontal surface) of the wearable device 1502 as described in FIG. 1. In some other embodiments, the flexure of the wearable device 1502 may include an edge surface (i.e., temples, arms) of the wearable device 1502. The flexure of the wearable device 1502 may be shaped to fit a configuration of a frame of the wearable device 1502. For example, it may be attached to a rim and to a temple piece by any means, such as bolting, pinning, riveting, swaging, threading, bonding by means of adhesives, soldering, and welding.

In some embodiments, a portion of the anterior surface of the flexure includes a mechanical housing that holds the camera assembly 1506, as described in FIG. 1. The mechanical housing may include an optical aperture that may include an opening having an anterior surface and the camera assembly 1506 may be positioned in relation to the anterior surface to track a gaze direction of a user wearing the wearable device 1502. The anterior surface may include a transparent material. In some embodiments, a size of the aperture is based on a size of the portion of the flexure of the wearable device 1502. In some embodiments, an axis of rotation of the flexure of the wearable device 1502 is proximate to the anterior surface of the wearable device 1502. For example, an axis of rotation of the flexure may be as close as possible to the front of a pair of eyeglass frames in order to keep the window aperture as small as possible.

In some embodiments, the camera assembly 1506 uses either a single lens or a lenslet array of the lens assembly 1504 to track a gaze direction of a user. Different regions, or facets of the single lens or the lenslet array of the lens assembly 1504 may have different optical functions. In some embodiments, different regions, or facets of the single lens or the lenslet array of the lens assembly 1504 have different infinity focus values. In some other embodiments, different regions, or facets of the single lens or the lenslet array of the lens assembly 1504 have different near focus values. In other embodiments, different regions, or facets of the single lens or the lenslet array of the lens assembly 1504 have different wide-angle values. In some embodiments, the lens regions are configured to match an optical function of the wearable device 1502, for example, smart eyeglasses prescription lenses including progressive lenses.

The camera assembly 1506 may be configured to provide, in some embodiments, a camera resolution of 400 pixels×3200 pixels. In some embodiments, an orientation of the camera assembly 1506 may be in a vertical column. A field-of-view width of the camera assembly 1506 may be 10 degrees (e.g., based on a user's central vision region being nominally 5 degrees wide, and a paracentral vision region being 8 degrees wide). The camera assembly 1506 may be swept +/−15 degrees, so that the camera assembly 1506 can monitor, scan, sense, etc. an entire viewing area of the user without head rotation. In some embodiment, beyond +/−15 degrees, the user will turn their head to look at an object.

The actuator 1508 may be a micro-electronic mechanical system (MEMS) actuator, an open-loop voice coil motor (VCM) actuator, or a closed-loop VCM, among other examples, configured to steer a camera array for HMD devices, such as the wearable device 100. In some embodiments, the actuator 1508 may be coupled to the camera assembly 1506 and configured to adjust a pointing direction of at least one camera sensor or a sensing orientation of the at least one camera sensor, or both, associated with the camera assembly 1506. For example, the camera assembly 1506 may be mounted on a flexure, and the actuator 1508 may be used to rotate the camera assembly 1506. An eye-tracking system of the wearable device 1502 may identify where a user is looking and can provide feedback to the wearable device 1502 (e.g., the camera assembly 1506). The camera assembly 1506 may see through a window (e.g., an aperture) that is integral to the wearable device 1502 (e.g., glasses frames).

The I/O controller 1510 can manage input and output signals for the wearable device 1502. The I/O controller 1510 can also manage peripherals not integrated into the wearable device 1502. In some embodiments, the I/O controller 1510 can represent a physical connection or port to an external peripheral. In some other embodiments, the I/O controller 1510 can utilize an operating system such iOS®, ANDROID®, MS-DOS®, MS-WINDOWS®, OS/2®, UNIX®, LINUX®, or another known operating system. The I/O controller 1510 can represent or interact with the modem 1522 (e.g., a 4G modem, a 5G modem), keyboard, a mouse, a touchscreen, or a similar peripheral device. The I/O controller 1510 can be implemented as part of the processor 1520. An end-user can interact with the wearable device 1502 via the I/O controller 1510 or via hardware components controlled by the I/O controller 1510.

The transceiver 1512 can communicate bi-directionally, via one or more antennas 1514. The transceiver 1512 can function as a receiver or a transmitter. For example, a receiver and a transmitter can be collocated in the transceiver 1512. When operating as a receiver, the transceiver 1512 can receive information such as packets, control information or user data associated with various information channels (e.g., control channels, data channels, and information related to various applications (e.g., VR applications, AR applications, etc.). Information can be passed on to other components of the wearable device 1502. When operating as a transmitter, the transceiver 1512 can transmit signals generated by other components of the wearable device 1502. The wearable device 1502 can include a single antenna 1514 or more than one antenna 1514, which can be capable of simultaneously transmitting or receiving data communications.

The memory 1516 can include a random-access memory (RAM) ora read-only memory (ROM). The memory 1516 can store computer-readable, computer-executable software 1518 including instructions that, when executed, cause the processor 1520 to perform various functions described herein. In some embodiments, the memory 1516 can include, among other components, a BIOS which can control basic hardware or software operation, such as interaction with peripheral components or devices. The software 1518 can include instructions to implement aspects of the present disclosure, including instructions to support steering a camera sensor or a camera sensor array of the camera assembly 1506 to track a gaze direction of a user wearing the wearable device 1502. The software 1518 can be stored in a non-transitory computer-readable medium such as system memory or other types of memory. In some embodiments, the software 1518 cannot be directly executable by the processor 1520 but can cause the wearable device 1502 (e.g., when compiled and executed) to perform functions described herein.

The processor 1520 can include an intelligent hardware device (e.g., a general-purpose processor, a DSP, a central processing unit (CPU), a microcontroller, an ASIC, an FPGA, or other programmable logic device, discrete hardware components, or any combination therefore). In some embodiments, the processor 1520 can be configured to operate a memory array using a memory controller. In some other embodiments, a memory controller can be integrated into the processor 1520. The processor 1520 can be configured to execute computer-readable instructions stored in the memory 1516 to cause the wearable device 1502 to perform various functions (e.g., functions or tasks supporting steering a camera sensor or a camera sensor array of the camera assembly 1506 to track a gaze direction of a user wearing the wearable device 1502).

The modem 1522 includes radio frequency interfaces configured to support various radio access technologies, for example, 4G LTE and 5G NR. The modem 1522 can be coupled to the processor 1520, the memory 1516, the transceiver 1512, etc., as described herein. The modem 1522 can modulate packets and provide the modulated packets to the transceiver 1512 for transmission. Similarly, the modem 1522 can receive packets from the transceiver 1512 and demodulate the received packets from the antennas 1514.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

The following provides an overview of examples of the present disclosure:

Example 1: A head wearable apparatus, comprising: a lens assembly including a lens module coupled to at least one surface of a frame of the head wearable apparatus; and a camera assembly operably coupled to an anterior surface of a flexure of the frame of the head wearable apparatus, wherein the flexure is adjacent to the lens assembly, the camera assembly including at least one sensor to track a gaze direction of a user.

Example 2: The head wearable apparatus of example 1, wherein the lens module comprises at least one lens or a lenslet array.

Example 3: The head wearable apparatus of example 1 or 2, further comprising: a processor; a memory coupled with the processor; and instructions stored in the memory and executable by the processor to cause the head wearable apparatus to: track a position of at least one eye of the user based on a direction of the at least one eye of the user, or an orientation of the at least one eye of the user, or both.

Example 4: The head wearable apparatus of at least one of the preceding examples, further comprising: an actuator coupled to the camera assembly and configured to adjust a pointing direction of the at least one camera sensor or a sensing orientation of the at least one camera sensor, or both.

Example 5: The head wearable apparatus of at least one of the preceding examples, wherein a portion of the anterior surface of the flexure comprises an aperture housing the camera assembly.

Example 6: The head wearable apparatus of example 5, wherein the aperture comprises an opening having an anterior surface and the camera assembly is positioned in relation to the anterior surface to track the gaze direction of the user.

Example 7: The head wearable apparatus of example 5, wherein the anterior surface comprises a transparent material.

Example 8: The head wearable apparatus of at least one of the preceding examples, wherein a size of the aperture is based on a size of the portion of the flexure of the head wearable apparatus in one or more dimensions including a direction and an orientation.

Example 9: The head wearable apparatus of at least one of the preceding examples, further comprising: a controller configured to control an operating mode of the at least one camera sensor of the camera assembly.

Example 10: The head wearable apparatus of at least one of the preceding examples, wherein an axis of rotation of the flexure of the head wearable apparatus is proximate to: the anterior surface of the head wearable apparatus, the lens assembly of the head wearable apparatus, a focal plane associated with the lens assembly of the head wearable apparatus, or another location of the head wearable apparatus.

Example 11: The head wearable apparatus of at least one of the preceding examples, wherein the camera assembly is in electrical communication with one or more components of the head wearable apparatus via an electrical interface coupled to the flexure of the head wearable apparatus, the one or more components comprising a processor, a memory coupled with the processor, or both, wherein the electrical interface comprises a printed circuit board.

Example 12: The head wearable apparatus of at least one of the preceding examples, wherein the lens assembly is coupled to the frame or the camera assembly.

Example 13: The head wearable apparatus of at least one of the preceding examples, wherein one or more camera sensors of an array of camera sensors of the camera assembly are coplanar.

Example 14: The head wearable apparatus of at least one of the preceding examples, wherein one or more camera sensors of an array of camera sensors of the camera assembly are non-coplanar.

Example 15: The head wearable apparatus of at least one of the preceding examples, wherein a dimension of the at least camera sensor of the camera assembly is different from a dimension of another camera sensor of the camera assembly.

Example 16: The head wearable apparatus of at least one of the preceding examples, wherein the camera assembly comprises: an array of camera sensors, wherein a height of the array of camera sensors is greater than a width of the array of camera sensors, or wherein the width of the array of camera sensors is greater than the height of the array of camera sensors.

Example 17: The head wearable apparatus of at least one of the preceding examples, further comprising: a display system coupled to the lens assembly to output visual information within the gaze direction of the user.

Example 18: The head wearable apparatus of at least one of the preceding examples, further comprising: a head mounted display comprising one or more of the lens assembly and the camera assembly.

Example 19: A pair of wireless-enabled eyeglasses, comprising: a lens assembly including a lens module coupled to at least one surface of a frame of the pair of wireless-enabled eyeglasses; and a camera assembly operably coupled to an anterior surface of a flexure of the frame of the pair of wireless-enabled eyeglasses, wherein the flexure is adjoining to the lens assembly, the camera assembly including a sensor to track a gaze direction of a user wearing the pair of wireless-enabled eyeglasses.

Example 20: The pair of wireless-enabled eyeglasses of example 19, wherein the lens module comprises at least one lens or a lenslet array.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head wearable apparatus, comprising:
a lens assembly including a lens module coupled to at least one surface of a frame of the head wearable apparatus; and
a camera assembly operably coupled to an anterior surface of a flexure of the frame of the head wearable apparatus, wherein the flexure is adjacent to the lens assembly, the camera assembly including at least one sensor to track a gaze direction of a user.

2. The head wearable apparatus of claim 1, wherein the lens module comprises at least one lens or a lenslet array.

3. The head wearable apparatus of claim 1, further comprising:
a processor;
a memory coupled with the processor; and
instructions stored in the memory and executable by the processor to cause the head wearable apparatus to:
track a position of at least one eye of the user based on a direction of the at least one eye of the user, or an orientation of the at least one eye of the user, or both.

4. The head wearable apparatus of at least one of claim 1, further comprising:
an actuator coupled to the camera assembly and configured to adjust a pointing direction of the at least one camera sensor or a sensing orientation of the at least one camera sensor, or both.

5. The head wearable apparatus of at least one of the preceding claims, wherein a portion of the anterior surface of the flexure comprises an aperture housing the camera assembly.

6. The head wearable apparatus of claim 5, wherein the aperture comprises an opening having an anterior surface and the camera assembly is positioned in relation to the anterior surface to track the gaze direction of the user.

7. The head wearable apparatus of claim 5, wherein the anterior surface comprises a transparent material.

8. The head wearable apparatus of claim 1, wherein a size of the aperture is based on a size of the portion of the flexure of the head wearable apparatus in one or more dimensions including a direction and an orientation.

9. The head wearable apparatus of claim 1, further comprising:
a controller configured to control an operating mode of the at least one camera sensor of the camera assembly.

10. The head wearable apparatus of claim 1, wherein an axis of rotation of the flexure of the head wearable apparatus is proximate to: the anterior surface of the head wearable apparatus, the lens assembly of the head wearable apparatus, a focal plane associated with the lens assembly of the head wearable apparatus, or another location of the head wearable apparatus.

11. The head wearable apparatus of claim 1, wherein the camera assembly is in electrical communication with one or more components of the head wearable apparatus via an electrical interface coupled to the flexure of the head wearable apparatus, the one or more components comprising a processor, a memory coupled with the processor, or both, wherein the electrical interface comprises a printed circuit board.

12. The head wearable apparatus of claim 1, wherein the lens assembly is coupled to the frame or the camera assembly.

13. The head wearable apparatus of claim 1, wherein one or more camera sensors of an array of camera sensors of the camera assembly are coplanar.

14. The head wearable apparatus of claim 1, wherein one or more camera sensors of an array of camera sensors of the camera assembly are non-coplanar.

15. The head wearable apparatus of claim 1, wherein a dimension of the at least camera sensor of the camera assembly is different from a dimension of another camera sensor of the camera assembly.

16. The head wearable apparatus of claim 1, wherein the camera assembly comprises:
an array of camera sensors, wherein a height of the array of camera sensors is greater than a width of the array of camera sensors, or wherein the width of the array of camera sensors is greater than the height of the array of camera sensors.

17. The head wearable apparatus of claim 1, further comprising:
a display system coupled to the lens assembly to output visual information within the gaze direction of the user.

18. The head wearable apparatus of claim 1, further comprising:
a head mounted display comprising one or more of the lens assembly and the camera assembly.

19. A pair of wireless-enabled eyeglasses, comprising:
a lens assembly including a lens module coupled to at least one surface of a frame of the pair of wireless-enabled eyeglasses; and
a camera assembly operably coupled to an anterior surface of a flexure of the frame of the pair of wireless-enabled eyeglasses,
wherein the flexure is adjoining to the lens assembly, the camera assembly including a sensor to track a gaze direction of a user wearing the pair of wireless-enabled eyeglasses.

20. The pair of wireless-enabled eyeglasses of claim 19, wherein the lens module comprises at least one lens or a lenslet array.
